(19) United States
(12) Patent Application Publication
(10) Pub. No.: US 2011/0022457 A1
(43) Pub. Date: Jan. 27, 2011

(54) LOCATION SPECIFIC PROMOTION OF STORE

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/841,378

(22) Filed: Jul. 22, 2010

Related U.S. Application Data
(60) Provisional application No. 61/227,547, filed on Jul. 22, 2009.

(51) Int. Cl. G06Q 30/00; G06K 19/06

(52) U.S. Cl. 705/14.38; 705/14.39; 235/494

(57) ABSTRACT

A method of promoting sales at specific store locations includes the step of providing a promotional website on the internet. The method also includes allowing a consumer to designate on that website a specific store location and a specific good or service for purchase at the designated store location. Further, the method includes sending a coupon for purchase of the designated good or service at the designated store location.

This application claims priority to U.S. Provisional Patent Application Ser. No. 61/227,547 filed 22 Jul. 2009, the entire disclosure of which is incorporated herein by reference.

### TECHNICAL FIELD AND INDUSTRIAL APPLICABILITY OF THE INVENTION

The present invention relates generally to the marketing field and, more particularly, to a method of marketing utilizing mobile phone text messaging.

### BACKGROUND OF THE INVENTION

The marketing of goods and services by means of mobile phone text messaging is a rapidly growing field. The concept of narrow casting text messages to existing or potential business customers is known. Relevant prior art patents include U.S. Pat. No. 6,754,314 to Wengrovitz et al, U.S. Pat. No. 7,197,324 to Sweeney and U.S. Pat. No. 7,437,413 to Okuyama et al.

The present invention relates to a new and improved method of marketing using a mobile phone text messaging service.

### SUMMARY OF THE INVENTION

In accordance with the purposes of the present invention as described herein, a method of promoting sales at a specific retail store location comprises providing a promotional website on the internet and allowing a consumer to designate both a specific retail store location and a specific good or service for purchase at the designated specific retail store location on that website. The method further includes the step of sending a coupon for purchase of the designated good or service at the designated specific retail store location. The coupon may include a bar code.

More specifically, the method may include sending the coupon directly to a mobile phone of the customer where the coupon is stored for future use. Alternatively, the coupon may be sent directly to the point of sale system at the designated specific retail store location. In that situation, the method further includes redeeming the coupon when the consumer checks out at the designated specific retail store location and purchases the specific good or service. Thus, the method includes the step of matching the coupon to the coupon requesting consumer or customer by a code or other means.

In accordance with yet another aspect of the present invention the method optionally includes determining the location of the consumer by monitoring the location of the mobile phone of the consumer and activating the mobile phone to send the coupon to the designated specific retail store location when the monitored location of the consumer matches the location of the designated specific retail store location. In other words, a coupon is only sent to the store location when the customer is at the store.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram illustrating the method of the present invention; and

FIG. 2 is a schematical block diagram illustrating the relationship between the various entities involved in the target marketing concept of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

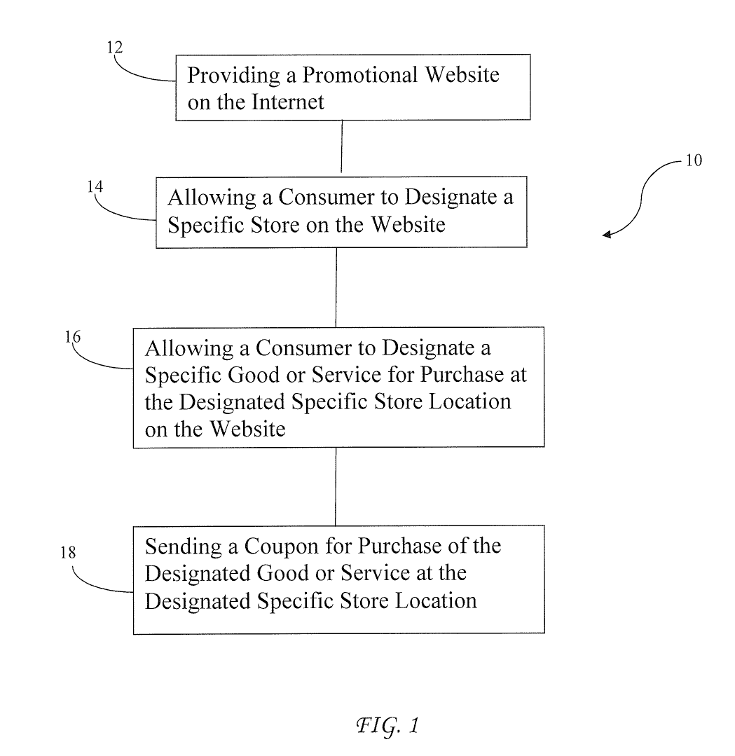

As illustrated in FIG. 1, the present invention relates to a method (10) of promoting sales of goods or services at a specific retail/wholesale store location that may be broadly described as comprising the steps of providing (12) a promotional website on the internet and allowing a customer/consumer to designate on that website a specific store location (14) and a specific good or service for purchase at that store (16). Further, the method includes sending a coupon for purchase of the designated good or service at the designated, specific store location (18).

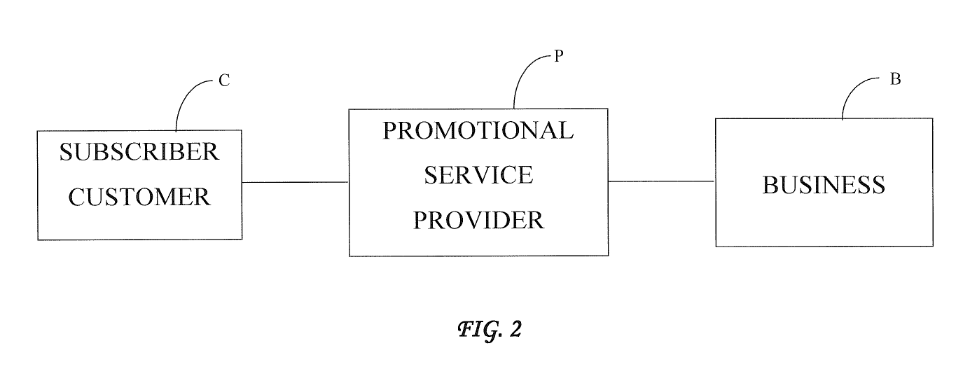

As illustrated in FIG. 2, a promotional service provider P is engaged by a business B to promote the business to subscriber customers C. Toward this end, the promotional service provider P utilizes a mobile phone text messaging service. Such a text messaging service is a permission based service requiring the registration of a customer or potential customer of the business B. Two mediums are provided for a customer C to join or subscribe to the text messaging service. The first provides for customer registration via an internet website. The second provides for customer registration via mobile phone texting. Thus, a potential customer or existing customer C may utilize his mobile phone to register via the cell phone registration medium.

In order to register, a customer C provides personal data which is stored in memory by the promotional service provider P. That data includes, but may not necessarily be limited to, residence information including address and mobile phone number. The individual or subscriber customer C registering may then review a list of businesses represented by the promotional service provider P via the text messaging service. The individual or subscriber customer C then selects those businesses B from which it is desired to receive discounts, coupons and other communication. This activates text messaging services whereby the promotional service provider P provides promotional information such as discount coupons of the selected business or businesses B to the subscriber customer C with pre-authorized customer approval.

All business customers C are then maintained on a list by the promotional service provider P. The system also provides a business B with an indication of how many times a particular individual or customer C has taken advantage of a coupon or special offer sent by text message. The service provider P is also able to indicate how many times a particular subscriber/customer has visited a specific store location of the business B. Thus, the list represents valuable marketing information stored and controlled by the promotional service provider P. This greatly increases the value of the service provided by the promotional service provider P to the business B which, in turn, provides the business with an incentive to maintain the service.

In accordance with one embodiment of the present invention, the purchase coupon is sent directly to the mobile phone of the subscriber customer/consumer C. The coupon may then be redeemed by the consumer when the consumer checks out at the designated store location and purchases the specific good or service covered by the coupon.

In an alternative embodiment, the mobile phone text messaging service provided by the promotional service provider P includes a global positioning satellite (GPS) monitor. The GPS monitor locates the individual subscriber customer/consumer C by monitoring the GPS feature of the mobile phone carried by that consumer. Once the consumer reaches the designated, specific store location, the promotional service provider P sends the coupon directly to the retail store location and more specifically the point of sale system at the designated specific store location. The method further includes the matching of the coupon to the coupon requesting consumer C by means of a code such as a bar code or any other appropriate means. Such a code or means may be transmitted to the mobile telephone of the consumer and shown to the cash register attendant at checkout. This is followed by the redeeming of the coupon when the consumer C checks out at the designated store location and purchases the specific good or service to which the coupon relates.

Thus, for example, the consumer may go to the promotional website on the internet and designate a particular brand of bleach to be purchased at a particular grocery store. A discount coupon for that bleach may then be sent directly to the consumer C. In the alternative embodiment the coupon will be sent directly to the specified grocery store when the GPS monitor determines that the consumer C is at the site of the grocery store. The coupon is then waiting at the checkout for use by the consumer.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of promoting sales at a specific store location, comprising:
providing a promotional website on the internet;
allowing a consumer to designate a specific store location on said website;
allowing a consumer to designate a specific good or service for purchase at said designated specific store location on said website; and
sending a coupon for purchase of said designated good or service at said designated specific store location.

2. The method of claim 1, wherein said coupon includes a bar code.

3. The method of claim 1, wherein said coupon is sent directly to a mobile phone of said consumer where said coupon is stored for future use.

4. The method of claim 3, including determining location of said consumer by monitoring location of mobile phone of said consumer and activating said mobile phone to send said coupon to said designated specific store location when said monitored location of said consumer matches location of said designated specific store location.

5. The method of claim 4, including redeeming said coupon when said consumer checks out at said designated specific store location.

6. The method of claim 1, wherein said coupon is sent directly to said point of sale system at said designated specific store location.

7. The method of claim 1, including redeeming said coupon when said consumer checks out at said designated specific store location.

8. The method of claim 7, including matching said coupon to said consumer by means of a code.
